(19) United States
(12) Patent Application Publication
(10) Pub. No.: US 2021/0344769 A1
(43) Pub. Date: Nov. 4, 2021

(54) NETWORK SECURITY LAYER

(71) Applicant: Perygee Inc., Falls Church, VA (US)

(72) Inventor: Mollie Breen, Falls Church, VA (US)

(73) Assignee: Perygee Inc., Falls Church, VA (US)

(21) Appl. No.: 17/302,219

(22) Filed: Apr. 27, 2021

Related U.S. Application Data
(60) Provisional application No. 63/017,788, filed on Apr. 30, 2020.

(51) Int. Cl. H04L 29/08; H04L 12/851; H04L 29/06; G06N 20/00; G06N 5/04

(52) U.S. Cl. CPC H04L 67/28; H04L 47/2441; H04L 63/1425; G06N 5/04; H04L 63/0236; G06N 20/00; H04L 63/0281

(57) ABSTRACT

A method performed by a server for protecting a network infrastructure can include: receiving, from an inline hardware appliance associated with an asset, traffic associated with the asset; analyzing the traffic based on a behavioral fingerprint associated with the asset to determine if the traffic is normal or abnormal, wherein the behavioral fingerprint can be stored on the server; and in response to determining that the traffic is normal, forwarding the traffic to the asset.

### CROSS-REFERENCE TO RELATED APPLICATIONS

This application claims priority to U.S. Provisional Application Ser. No. 63/017,788, dated Apr. 30, 2020, the content of which is incorporated herein by reference in its entirety.

### BACKGROUND

Enterprises are adding connected assets at an exponential rate. This increase in volume makes it hard to secure each individual asset at every stage of their life cycle. A new consumer internet of things device (IoT) and an older operational technology (OT) asset will have different vulnerabilities and need different set of processes to protect it, and yet can coexist on the same network. Examples of connected assets span across industries and technology including: MRIs, hospital beds, thermometers, wind turbines, manufacturing conveyor belts, light bulbs, security cameras, and various types of sensors and actuators. From the manufacturer's perspective, they are not incentivized to support or update these assets as they are focused on building the next generation of products. From the enterprise's perspective, it can be challenging to track where each asset is in its life cycle and to update the assets due to the dependencies in the network. Even in a system where there is communication between manufacturers and enterprises to secure connected assets, there can be significant delays between a manufacturer releasing an update for a working device and the device actually receiving the update. The unsupported and unpatched nature of these assets can leave them susceptible to hacking and can create a weak point in a network architecture.

### SUMMARY

According to one aspect of the present disclosure, a method performed by a server for protecting a network infrastructure can include: receiving, from an inline hardware appliance that proxies traffic associated with a device, traffic associated with the asset; analyzing the traffic based on a behavioral fingerprint associated with the asset to determine if the traffic is normal or abnormal, wherein the behavioral fingerprint can be stored on the server; and in response to determining that the traffic is normal, forwarding the traffic to the asset. In some embodiments, the method can include: determining if the traffic is incoming or outgoing; and in response to determining that the traffic is incoming and abnormal, blocking the traffic from being received by the asset. In some embodiments, determining that the traffic is abnormal can include determining that the traffic will cause downtime on the asset.

In some embodiments, the method can include determining if the traffic is incoming or outgoing; and in response to determining that the traffic is outgoing and abnormal, determining that the asset is compromised. In some embodiments, the method can include, in response to determining that the asset is compromised, gaining remote control of the asset. In some embodiments, the method can include performing remote command executions on the asset with existing libraries of the asset. In some embodiments, the method can include, in response to determining that the asset is compromised, isolating the asset from other assets on the network infrastructure. In some embodiments, the method can include updating the behavioral fingerprint.

According to another aspect of the present disclosure, a method performed by a server for protecting a network infrastructure can include receiving identification information for a plurality of assets on a network; and, for each asset: connecting the asset through an inline hardware appliance that proxies traffic, wherein the inline hardware appliance can be configured to route traffic associated with the asset to the server; generating a behavioral fingerprint for the asset; storing the behavioral fingerprint on the server; and using the behavioral fingerprint to control traffic associated with the asset.

In some embodiments, generating the behavioral fingerprint for the device can include monitoring traffic associated with the device continuously and for a predetermined length of time; and generating the behavioral fingerprint based on the received traffic data. In some embodiments, traffic data can include at least one of: frequencies of traffic; identification information of other assets that communicate with the asset; traffic packet sizes; traffic packet timestamps; time and duration information from when the asset is turned off; time and duration information from when the asset is turned on; or sensor data from a sensor of the asset.

In some embodiments, generating the behavioral fingerprint based on the received traffic data can include using machine learning to generate an algorithm configured to predict whether a traffic packet associated with the asset is normal or abnormal. In some embodiments, using the behavioral fingerprint to control traffic associated with the asset can include: receiving, from the inline hardware appliance, a traffic packet associated with the asset; analyzing the traffic packet based on the behavioral fingerprint to determine if the traffic packet is normal or abnormal; and in response to determining that the traffic packet is normal, forwarding the traffic packet to the asset.

In some embodiments, the method can include determining if the traffic packet is incoming or outgoing; and in response to determining that the traffic packet is incoming and abnormal, blocking the traffic packet from being received by the asset. In some embodiments, the method can include determining if the traffic packet is incoming or outgoing; and in response to determining that the traffic packet is outgoing and abnormal, determining that the asset is compromised. In some embodiments, the method can include, in response to determining that the asset is compromised, controlling the asset using only resources of the asset. In some embodiments, the method can include updating the behavioral fingerprint. In some embodiments, connecting the asset to the inline hardware appliance can include configuring the inline hardware appliance to route all traffic associated with a media access control (MAC) address of the asset to the server.

According to another aspect of the present disclosure, a system for protecting a network infrastructure can include: a network; a plurality of assets connected to the network; and a server connected to the network. The server can include a plurality of proxies. The server can be configured to, for each asset on the network: connect a proxy to the asset; generate a behavioral fingerprint for the asset; store the behavioral fingerprint on the server; and use the behavioral fingerprint to control traffic associated with the asset. Each proxy of the plurality of proxies can be configured to route traffic associated with a connected asset to the server. In some embodiments, generating the behavioral fingerprint can include using machine learning to generate an algorithm configured to predict whether a traffic packet associated with the connected asset is normal or abnormal.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a network layer infrastructure with operational technology (OT) security issues.

FIG. 2 is a network layer infrastructure that can protect against OT security issues, according to some embodiments of the present disclosure.

FIG. 3 is a network security system, according to some embodiments of the present disclosure.

FIG. 4 is a flow diagram showing processing that may occur to set up a device for protection, according to some embodiments of the present disclosure.

FIG. 5 is a flow diagram showing processing that may occur to protect a device, according to some embodiments of the present disclosure.

FIG. 6 is a flow diagram showing processing that may occur within a system for protecting a network infrastructure, according to some embodiments of the present disclosure.

FIG. 7 is an example server device, according to some embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

The following detailed description is merely exemplary in nature and is not intended to limit the invention or the applications of its use.

Embodiments of the present disclosure relate to a security layer for protecting a network infrastructure by securing devices, such as legacy OT devices, that are on the network. For a device on a network, the system may employ an inline hardware device that proxies traffic and operates between the device and the gateway to the internet. The proxy may intercept all traffic in and out of the device and route the traffic to a central server. In some embodiments, the server may be operated by a customer or company for which the network belongs. In some embodiments, the server may be operated by an independent third party. In some embodiments, the server may learn the normal behavior of the device and evaluate all incoming and outgoing traffic with regard to the device's “normal behavior” (herein referred to as a behavioral fingerprint). In response to detecting traffic that is out of the ordinary (herein referred to as abnormal behavior), the server may prevent the traffic from reaching the device as a security measure. In response to detecting traffic that is ordinary or normal, the server may allow the traffic to be received by the device and may update the device's behavioral fingerprint to reflect this traffic (e.g. via continuous or real-time learning). Intercepting all traffic to and from a device may protect the device from vulnerabilities and susceptibilities to being hacked, removing a common access point for hackers to the network. In some embodiments, a plurality of devices may exist on a network, in which case a plurality of device-specific proxies may be used to secure the devices. In some embodiments, in addition to protecting the network from unwanted or malicious access and decreasing operational risk, the security layer may provide benefits such as extending the lifetime of devices, providing significant increases to their availability and performance, and enhancing the ability to manage a device throughout its life cycle.

For example, an organization may have a large number of unprotected devices or legacy OT devices built up over time on their network. The organization may hire a third-party to protect and/or secure these devices via the embodiments described herein. The third-party may utilize their own servers to perform the described processes, or these processes may be configured to be run on servers owned by the organization.

A standard life cycle in information technology (IT) (e.g. telecommunications equipment and devices that can store, transmit, manipulate, and protect data) can be around two to three years, meaning new and improved technology is released relatively often. Conversely, a common life cycle for operational technology can be up to fifteen or twenty years. As a result, it can be commonplace for assets operating within a network infrastructure to not be frequently updated or to be much older than the IT devices managing the network. In addition, many current cybersecurity solutions can only offer protection to endpoints on a network infrastructure that have their own computational processes to manage a security software like computers or servers. But because of the abundance of legacy OT devices on the network that do not have enough computational resources to run a security software, typical cybersecurity solutions can leave these devices exposed to the open internet and unprotected. Additionally, putting security software onto old technology can sometimes have negative, unintended consequences. For example, the operation of the software can mimic a denial of service attack and possibly cause the device to shut itself down.

In many applications, legacy OT devices can be connected to critical infrastructure such as electricity or critical medical equipment. Outages and hacking on these networks can potentially have serious consequences. Furthermore, while it may theoretically be beneficial to replace legacy OT on a network with current, more advanced technology, this is not often a viable option due to the time-consuming and expensive nature of such a replacement process. This type of maintenance could also lead to disruptions on existing device dependencies and possibly substantial downtime within the system.

One example of a serious consequence of the mismanagement of legacy devices on a network is an entire hospital wing going offline. At a major university hospital, an entire wing went down because of an infected device. The hospital had no viable method of securing the array of legacy devices connected to the network and, because of budget constraints, was unable to update and/or replace the legacy devices. This left the devices vulnerable and unprotected, and a network infiltration via a legacy device caused the wing to shut down. Another example of a negative consequence of too many OT devices on a network comes from an experience at a university. A device on the network was misbehaving, but the security team had trouble locating the source of the misbehavior. In IT, when a device misbehaves, it can be relatively simple to find because the device is typically associated with a particular user. In OT, it can be much harder to find a misbehaving device as there is little to no visibility into changes in device behavior and they are not tied to users. Rather than spending large amounts of money to pin down the source, the increased visibility of the embodiments of the present disclosure could provide a much more effective solution. A third example involves a railroad network: railroad systems typically involve vast arrays of sensors (e.g. location and track monitoring sensors) that can be critical to monitoring the health of railroad tracks and train performance. However, replacing remote devices like this for updates or replacement can be undesirably costly, and, as a result, companies can often be forced to persist with old devices. Embodiments of the present disclosure could help secure remote OT devices such as these without the need for sending a human operator out to remote locations.

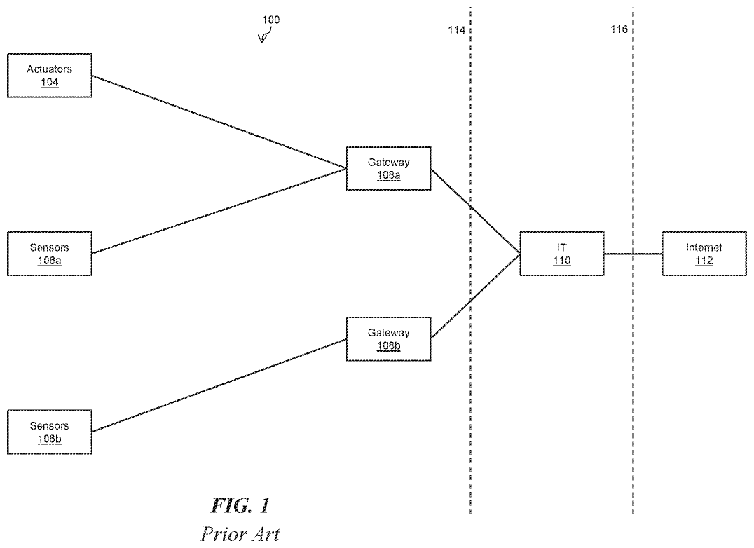

FIG. 1 is a network layer infrastructure 100 with operational technology (OT) security issues. Infrastructure 100 is exemplary of a typical IT/OT environment, where IT devices are used to manage a network that also has OT devices connected to it. Infrastructure 100 can be an infrastructure of an organization or a location (e.g. a hospital or university). Infrastructure 100 can include one or more actuators 104 and sensors 106a-b. Note, infrastructure is merely an example and may include many more actuators and/or sensors. Sensors 106 may be any type of sensor, such as sensors that monitor the surrounding environment. Actuators 104 may control the surrounding environment. In some embodiments, as described herein, OT devices may refer to sensors and/or actuators. These devices can be embedded with internet connectivity. Actuators 104 and sensors 106 can be connected to the internet via WiFi, Bluetooth, Zigbee, cellular, or other similar connection protocols, such as proprietary protocols.

Other examples of OT devices may include programmable logic controllers (PLCs), supervisory control and data acquisition systems (SCADA), distributed control systems (DCSs), computer numerical control (CNC) systems or other computerized machine tools, scientific equipment such as digital oscilloscopes, building management and building automation systems (BMS/BAS), lighting controls, energy monitoring, security and/or safety systems, transportation systems and any other systems that can process operational data (e.g. electronic, telecommunications, computer systems, and technical components). In some embodiments, OT devices can control valves, engines, conveyors, and other machines to regulate process values such as temperature, pressure, flow, and others and to prevent hazardous conditions. Infrastructure 100 can be vulnerable to hacking or unwanted access. It may be relatively simple, although hard to detect, for a hacker to gain access to the network infrastructure 100 via an actuator 104 or sensor 106. These devices no longer receive updates (such as software updates) from the manufacturer. However, a common method of hacking involves spoofing a manufacturer update to gain access to the device.

Infrastructure 100 may also include gateways 108a-b (gateways 108 generally). In some embodiments, gateway 108a may be made by an original equipment manufacturer (OEM) A and gateway 108b may be made by an original equipment manufacturer (OEM) B. Sensors 106a may also be of OEM A and sensors 106b may be of OEM B. In some embodiments, gateways 108 can aggregate data for analysis and can be located near an edge device, such as a router, routing switcher, or network access devices. In some embodiments, the connection protocol between gateways 108 and sensors 106 or actuators 104 may also be Wifi, Bluetooth, Zigbee, cellular, or other similar protocols, such as proprietary protocols. Infrastructure 100 may also include IT components 110 for managing the infrastructure and performing standard IT processes, as well as connecting devices on the network infrastructure to the internet 112. In some embodiments, dotted line 114 may signify the transition between IT and OT devices. In some embodiments, the dotted line 116 may signify the transition between a network and the open internet.

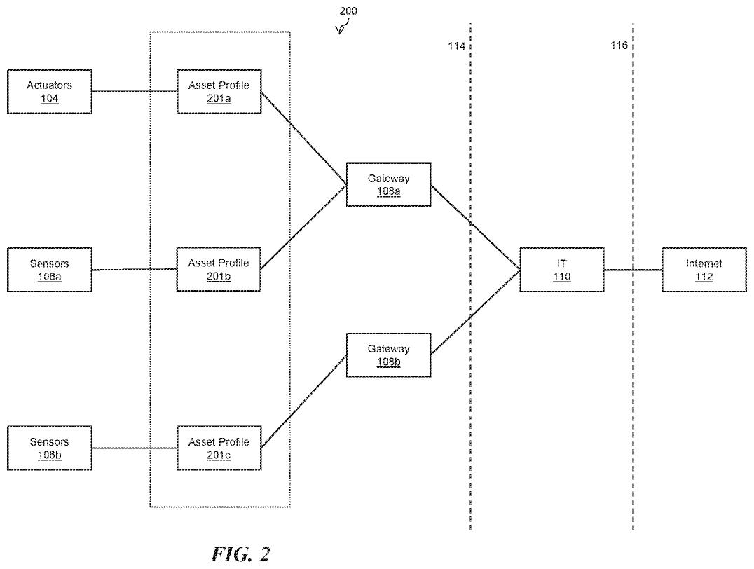

FIG. 2 depicts a network layer infrastructure 200 that can protect against OT security issues, according to some embodiments of the present disclosure. Infrastructure 200 may be the same as infrastructure 100 of FIG. 1 with an additional layer of components. In some embodiments, infrastructure 200 may include one or more asset profiles 201a-c (asset profiles 201 generally or profile 201 singularly). As described herein, a profile 201 may refer to a digital, software model of a physical device and can be referred to as an inline hardware appliance. In some embodiments, the profile 201 can interface between the physical device and the rest of the network. Each profile 201 may be connected to a device and may be configured to route traffic to and from the device to a server for processing. In some embodiments, each profile 201 may be device-specific and may operate between the physical device and the associated gateway 108. Each profile 201 may be configured to help prevent important data from flowing out of the network to unknown sources and may prevent malicious or unwanted traffic flowing in and/or out of the network.

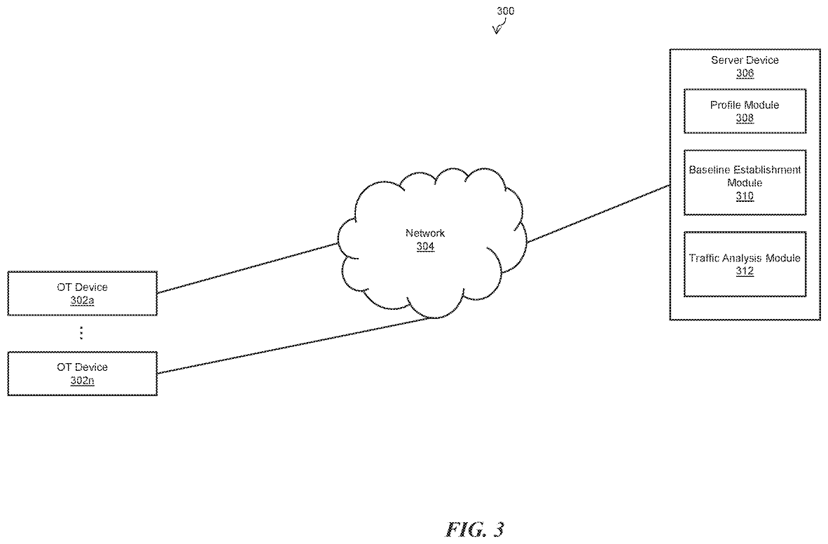

FIG. 3 depicts a network security system 300, according to some embodiments of the present disclosure. System 300 may include a server device 306 communicably coupled to a plurality of OT devices 302a-n (302 generally) via a network 304. OT devices 302 may include a variety of OT devices as described in relation to FIG. 1. As described herein, devices 302 can be referred to as assets or endpoints.

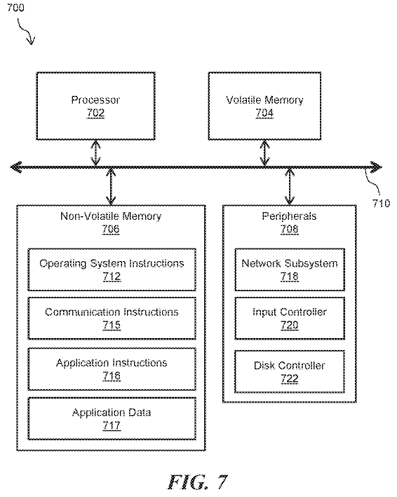

Server device 306 may include any combination of one or more of web servers, mainframe computers, general-purpose computers, personal computers, or other types of computing devices. Server device 306 may represent distributed servers that are remotely located and communicate over a communications network, or over a dedicated network such as a local area network (LAN). Server device 306 may also include one or more back-end servers for carrying out one or more aspects of the present disclosure. In some embodiments, server device 306 may be the same as or similar to server device 700 described below in the context of FIG. 7.

As shown in FIG. 3, server device 306 can include profile module 308, baseline establishment module 310, and traffic analysis module 312. In some embodiments, profile module 308 can include one or more proxies. In some embodiments, profile module 308 can include a plurality of proxies for the plurality of OT devices 302; each profile can be connected to each OT device 302 on the network that a user or group wishes to be protected and/or secured. In some embodiments, each profile may be configured to route traffic associated with the connected OT device to server device 306. In some embodiments, traffic routing may be based on media access control (MAC) addresses or other identification information associated with the OT device. In some embodiments, profile module 308 may be stored separately from the server, such as in a cloud storage platform (e.g. stored in the cloud).

In some embodiments, baseline establishment module 310 may be configured to establish a behavior baseline for a device 302. In some embodiments, baseline establishment module 310 may be configured to generate a behavioral fingerprint for the device 302. In some embodiments, baseline establishment module 310 may be configured to generate behavioral fingerprints for a plurality of devices 302 in the system 300. To generate a behavioral fingerprint, baseline establishment module 310 may be configured to, for a predetermined length of time, monitor a portion of or all traffic (e.g. both incoming and outgoing) associated with the device 302. In some embodiments, baseline establishment module 310 may be configured to receive traffic data of the traffic received in the predetermined length of time. Traffic data may include frequencies of types of traffic, identification information of other devices that communicate with the device (e.g. the device that device 302 sends traffic to or receives traffic from), traffic packet sizes, traffic packet timestamps, time and duration information from when the device 302 is turned off and turned on, and/or sensor data from the device 302. Baseline establishment module 310 may be configured to generate a behavioral fingerprint based on the received traffic data. As described herein, a behavior fingerprint may refer to a model unique to a device and may be created by machine learning. In some embodiments, the behavioral fingerprint may be used to predict whether future traffic is “normal” or “abnormal.” In some embodiments, baseline establishment module 310 may be configured to use machine learning to train or generate an algorithm to predict whether a traffic packet associated with the device 302 is normal or abnormal. In some embodiments, the behavioral fingerprint may include any algorithms trained via machine learning.

In some embodiments, traffic analysis module 312 may be configured to analyze traffic associated with one or more devices 302 that has been routed by profile module 308. In some embodiments, traffic analysis module 312 may be configured to analyze traffic data with a behavioral fingerprint to determine if traffic (or, if referring to a singular traffic event, a traffic packet) is normal or abnormal. Traffic analysis module 312 may be configured to determine if the traffic is incoming or outgoing. In some embodiments, traffic analysis module 312 may be configured to determine if a device has been compromised. A compromised device may refer to a device that has been hacked or is behaving abnormally. In some embodiments, server device 306 may be configured to take certain actions based on determinations made by the traffic analysis module 312. For example, server device 306 may be configured to allow traffic to reach device 302 or block traffic from reaching device 302. Server device 306 may also be configured to send out notifications in response to detecting that a device 302 has been compromised. In some embodiments, server device 306 may be configured to control a compromised device 302 or perform relevant security actions by only using resources or software agents pre-installed on the device 302.

Network 304 may include one or more wide areas networks (WANs), metropolitan area networks (MANs), local area networks (LANs), personal area networks (PANs), or any combination of these networks. Network 304 may include a combination of one or more types of networks, such as Internet, intranet, Ethernet, twisted-pair, coaxial cable, fiber optic, cellular, satellite, IEEE 801.11, terrestrial, and/or other types of wired or wireless networks. Network 304 can also use standard communication technologies and/or protocols.

In some embodiments, the server 306 is configured to cause a user interface to be displayed on a device for review by an analyst or other maintenance personnel. The user interface may include a section that displays a device hygiene score describing the health of the network infrastructure. In some embodiments, the device hygiene score may be based on the total number of devices updated, the number of unnecessary ports closed, and the number of passwords changed. In some embodiments, the user interface may also include a search bar that can allow a user the ability to search for a specific device on the network, for example by MAC address.

In some embodiments, the device hygiene score may reflect the health and/or hygiene levels of a device and may include multiple weighted factors. This may include both internal health (e.g. software) and external health (e.g. cleanliness of the physical device). For example, in a hospital setting, devices are often reused on multiple patients. The hygiene score for the device may include a weight that reflects the extent to which the device is properly wiped down. In some embodiments, the hygiene score can be a score based out of 100.

The various system components—such as modules 308-312—may be implemented using hardware and/or software configured to perform and execute the processes, steps, or other functionality described in conjunction therewith.

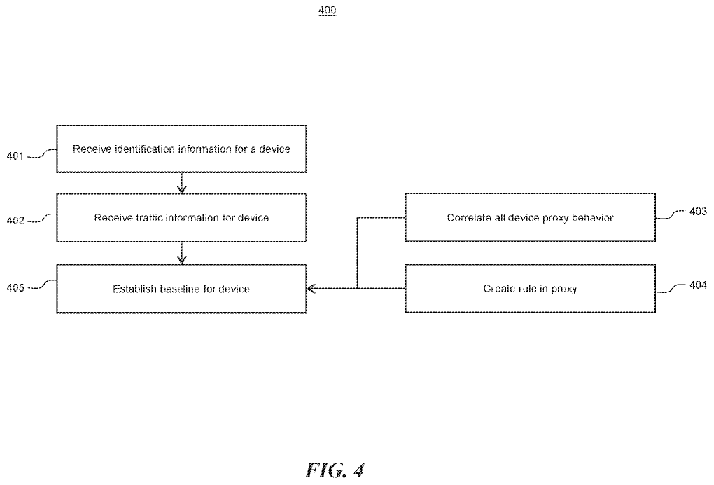

FIG. 4 is a flow diagram showing process 400 that may occur to set up a device for protection, according to some embodiments of the present disclosure. Process 400 may be performed by server device 306. Note, process 400 is an illustrative process for setting up a single device with a server; however, a server of the present disclosure may be configured to perform this process multiple times either concurrently or sequentially to set up a plurality of devices on a network. In some embodiments, the device may be a legacy OT device on a network.

At block 401, server device 306 may discover an asset or receive identification to track the asset. The asset may be any of devices 302a-n. In some embodiments, identification information may include a media access control (MAC) address of the device. At block 402, profile module 308 may receive traffic information for the device. In some embodiments, the information may be received over a pre-determined length of time. The pre-determined length of time may be referred to as a training period or setup period. The traffic information received in this time period may be used to analyze and learn the behavior of the device.

At block 405, baseline establishment module 310 may establish a baseline for the device. In some embodiments, establishing a baseline may include analyzing the traffic behavior of the device and continuously generating a behavioral fingerprint based on the traffic. In some embodiments, baseline establishment module 310 may generate the behavioral fingerprint by analyzing traffic data associated with the device obtained in the pre-determined length of time. Traffic data may include frequencies of traffic, identification information of other devices that communicate with the device, traffic packet sizes, traffic packet timestamps, time and duration information from when the device is turned on and off, and/or sensor data (e.g. temperature data from a thermometer on the device) from a sensor of the device. In some embodiments, traffic may be to/from other OT devices on the network, IT devices on the network, or the internet. In some embodiments, baseline establishment module 310 may be configured to use machine learning to generate an algorithm configured to predict whether a traffic packet associated with the device is normal or abnormal. In some embodiments, abnormal behavior may be malicious behavior, although it is not limited to malicious behavior. For example, if a trojan or something else malicious was detected as being sent to a device, the behavioral fingerprint may be able to predict this as an abnormal traffic event. In addition, as an example of non-malicious abnormal behavior, the behavioral fingerprint may be able to detect a piece of traffic that, although not inherently malicious, would not normally be sent to the device, perhaps because it was already sent. In other words, the behavioral fingerprint may be able to detect repetitive or unnecessary traffic. Detecting abnormal, non-malicious traffic events can help to improve the availability and performance of the device. In some embodiments, after the behavioral fingerprint is generated, it may be stored on the server.

In some embodiments, prior to performing block 405, baseline establishment module 310 may perform blocks 403 and 404. At block 403, baseline establishment module 310 may correlate device proxy behavior. In some embodiments, the correlation of other device proxy behavior on the network may be an additional input in generating the behavior fingerprint. The behavioral fingerprint for a device may thus also consider how the device behaves with respect to other devices on the network. For example, the behavior of a fire alarm system may be correlated with the behavior of a thermostat on the same network. It may be difficult to detect if abnormal behavior is occurring for a fire alarm system without considering other behaviors. If a fire alarm is going off but the thermostat reads 72 degrees Fahrenheit, or if the fire alarm is not going off and the thermostat experiences a quick rise to temperatures over 100 degrees Fahrenheit, the behavioral fingerprint may be able to predict both of these occurrences as abnormal events, whereas standard security systems may not.

At block 404, baseline establishment module 310 may create a rule in the proxy. In some embodiments, creating a rule in the proxy may occur in response to discovering or detecting a new vulnerability of the device. Vulnerabilities may be discovered and kept track of by industries. For example, certain websites and/or databases (e.g. cve.mitre.org or the National Vulnerability Database (NVD)) may keep track of vulnerabilities by device in a continuously updated log. An example vulnerability is CVE-2018-11315. This vulnerability is found on a particular model of thermostat that shows it is susceptible to a DNS (Domain Name System) rebinding attack. Baseline establishment module 310 may be configured to monitor resources such as this to keep track of and discover new vulnerabilities and implement such vulnerabilities into the behavioral fingerprint. In the example of CVE-2018-11315, a behavioral fingerprint for the associated thermostat may include a rule that rejects DNS replies. In some embodiments, baseline establishment module 310 may be configured to continuously monitor third-party resources and continuously update behavioral fingerprints to reflect vulnerabilities.

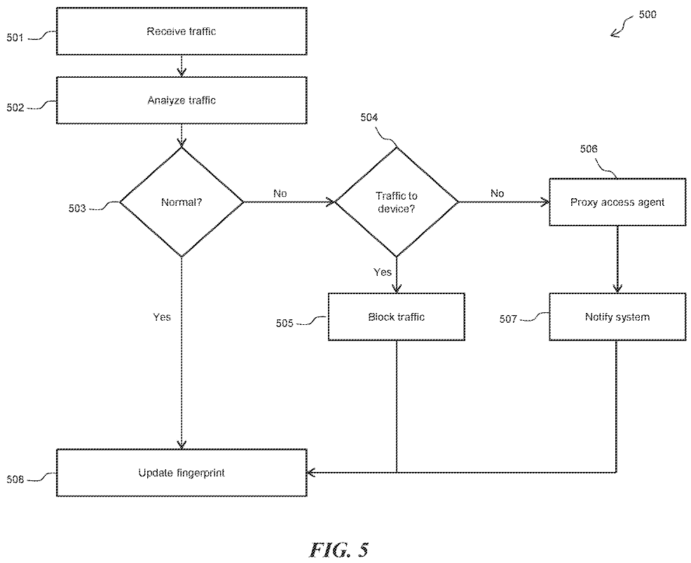

FIG. 5 is a flow diagram showing process 500 that may occur to protect a device, according to some embodiments of the present disclosure. In some embodiments, server device 306 may perform process 500 to protect a device, such as a device 302 or the device that was set up in FIG. 4. In some embodiments, process 500 may be used after a behavioral fingerprint has been generated for a device. For example, an organization with a network that contains legacy OT devices may employ a third-party to set up one or more of the legacy devices, such as described with relation to FIG. 4. After the one or more behavioral fingerprints have been generated and set up, the devices and network may return to a typical, every-day operation. Process 500 may be used on a regular basis to protect the devices set up during normal operation. Process 500 is described with respect to a single device. However, this is merely illustrative and not limiting. Process 500 may be performed multiple times sequentially or simultaneously for a plurality of devices on a network.

At block 501, proxy module 308 may receive traffic associated with a device. For example, a proxy contained within proxy module 308 may receive traffic associated with the device it is connected to (see blocks 401-402 of FIG. 4). In some embodiments, the receiving may be based on the MAC address of the asset or a discovered asset. For example, a computer somewhere on a network may send a request to an MRI machine (the MRI machine being the device). Before the MRI machine can receive the request (herein referred to as a traffic packet), the proxy module 308 may receive the traffic packet before it reaches the MRI. In some embodiments, this may be referred to as intercepting the traffic packet or routing the traffic packet to the server, as the proxy is contained on the server.

At block 502, traffic analysis module 312 may analyze the traffic received in block 501. In some embodiments, traffic analysis module 312 may be configured to use a behavioral fingerprint associated with the asset (e.g. the behavioral fingerprint generated in process 400) to predict whether the traffic packet is normal or abnormal. At block 503, if the traffic packet is determined to be normal, server device 306 may forward the traffic packet to the device or send the traffic packet to the recipient (assuming the traffic packet originated from the device). In essence, the profile module 308 receives traffic to and from the device, allowing for analysis prior to allowing the traffic packet to reach the intended recipient. This may protect the device (e.g. the OT device) from unwanted or malicious traffic. After determining that the traffic packet is normal, processing may proceed to block 508. At block 508, the baseline establishment module 310 may update the behavioral fingerprint to reflect the traffic. In some embodiments, this may be referred to as continuous or real-time learning, which may allow for behavioral fingerprints to always be up to date.

In some embodiments, when determining if traffic associated with a device is normal, traffic analysis module 312 may also consider the availability of the device. This may be referred to as pre-processing the traffic. In some embodiments, pre-processing traffic may also include traffic analysis module 312 scheduling firmware updates for OT devices on the network to reduce downtime and increase availability of the devices. In some embodiments, traffic analysis module 312 may be configured to provide recommendations to a user (e.g. a managing IT professional, internet security officer, etc.) on scheduling firmware updates. In some embodiments, traffic analysis module 312 may automatically distribute firmware updates. In some embodiments, traffic analysis module 312 may be configured to identify features not being used at a certain, pre-defined frequency (e.g. ports, user settings, etc.) and recommending to a user that the feature be turned off. This may further prevent unwanted traffic within the network.

At block 503, if the traffic packet is determined to be abnormal based on the behavioral fingerprint, analysis may proceed to block 504. At block 504, the traffic analysis module 312 may determine if the traffic is incoming to or outgoing from the device. In response to determining that the traffic is incoming to the device (e.g. the traffic packet is incoming and abnormal), at block 505, server device 306 may block the traffic from reaching the device. This may prevent unwanted, malicious, or risky traffic from reaching the device and potentially compromising it. It may also help increase the availability of the device. After blocking traffic from being received by the device, processing may proceed to 508. At block 508, baseline establishment module 310 may update the behavioral fingerprint to reflect the abnormal behavior. In some embodiments, when analyzing traffic, traffic analysis module 312 may be configured to predict whether traffic will cause downtime on the device. In some embodiments, traffic that is predicted to cause downtime on the device may be considered to be abnormal and may be blocked from reaching the device by server device 306.

At block 504, in response to determining that the traffic is outgoing from the device, traffic analysis module 312 may determine that the device is compromised, and processing may proceed to block 506. At block 506, server device 306 may be configured to gain remote control of the compromised device. In some embodiments, gaining remote control may include implementing a secure shell (SSH) protocol. For example, server device 306 may use the SSH protocol to perform remote command executions on the device. In some embodiments, only libraries existing on the compromised device may be utilized to execute commands. This may allow server device 306 to cut off or isolate the device from the rest of the network infrastructure or test it for existing vulnerabilities or accessibility of potential exploits. In some embodiments, server device 306 may be configured to analyze the compromised device to determine if the device was hacked. In some embodiments, utilizing the libraries already on the device may prevent bugs on the device that may result from installing a third-party agent. At block 507, server device 306 may notify the system, system administrator, or network administrator that the device is compromised. In some embodiments, the notification may include the MAC address of the compromised device and other information and/or data related to the abnormal traffic detected. Once again, at block 508, baseline establishment module 310 may update the behavioral fingerprint to reflect the abnormal behavior.

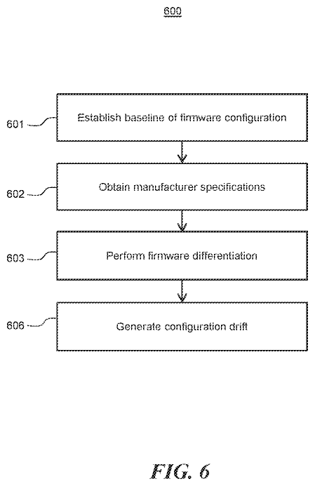

FIG. 6 is a flow diagram showing process 600 that may occur within a system for protecting a network infrastructure, according to some embodiments of the present disclosure. In some embodiments, process 600 may be performed to generate a configuration drift for an OT device on a network infrastructure, such as actuators 104 and/or sensors 106 of FIG. 1 and OT devices 302 of FIG. 3. In some embodiments, process 600 may be performed by server device 306. At block 601, server device 306 may establish a baseline of firmware configuration for a device. In some embodiments, establishing a baseline of firmware configuration for a device may include analyzing sensor range or power consumption, as well as access privileges or number of ports open. At block 602, server device 306 may obtain manufacturer specifications for the device. At block 603, server device 306 may perform firmware differentiation on the device. In some embodiments, performing firmware differentiation may include determining how much the firmware of the device has changed, for example since its initial release (e.g. factory settings). At block 606, server device 306 may generate the configuration drift for the device. In some embodiments, the configuration drift may be a numerical score or metric that traces how much the device has changed from its original specifications. In some embodiments, the configuration drift may be a percentage or a decimal. In some embodiments, server device 306 may be configured to monitor firmware changes of devices on the associated network infrastructure and update configuration drifts accordingly. Configuration drift may also allow a user to trace the source/location where the drift happened so they can inspect the changes that caused it.

FIG. 7 is a diagram of an illustrative server device 700 that can be used within system 300 of FIG. 3, according to some embodiments of the present disclosure. Server device 700 may implement various features and processes as described herein. Server device 700 may be implemented on any electronic device that runs software applications derived from complied instructions, including without limitation personal computers, servers, smart phones, media players, electronic tablets, game consoles, email devices, etc. In some implementations, server device 700 may include one or more processors 702, volatile memory 704, non-volatile memory 706, and one or more peripherals 708. These components may be interconnected by one or more computer buses 710.

Processor(s) 702 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 710 may be any known internal or external bus technology, including but not limited to ISA, EISA, PCI, PCI Express, NuBus, USB, Serial ATA, or FireWire. Volatile memory 704 may include, for example, SDRAM. Processor 702 may receive instructions and data from a read-only memory or a random access memory or both. The essential elements of a computer may include a processor for executing instructions and one or more memories for storing instructions and data.

Non-volatile memory 706 may include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 706 may store various computer instructions including operating system instructions 712, communication instructions 715, application instructions 716, and application data 717. Operating system instructions 712 may include instructions for implementing an operating system (e.g., Mac OS®, Windows®, or Linux). The operating system may be multi-user, multiprocessing, multitasking, multithreading, real-time, and the like. Communication instructions 715 may include network communications instructions, for example, software for implementing communication protocols, such as TCP/IP, HTTP, Ethernet, telephony, etc. Application instructions 716 can include instructions for protecting OT devices according to the systems and methods disclosed herein. For example, application instructions 716 may include instructions for components 308-312 described above in conjunction with FIG. 3. Application data 717 may include data corresponding to 308-312 described above in conjunction with FIG. 3.

Peripherals 708 may be included within server device 700 or operatively coupled to communicate with server device 700. Peripherals 708 may include, for example, network subsystem 718, input controller 720, and disk controller 722. Network subsystem 718 may include, for example, an Ethernet of WiFi adapter. Input controller 720 may be any known input device technology, including but not limited to a keyboard (including a virtual keyboard), mouse, track ball, and touch-sensitive pad or display. Disk controller 722 may include one or more mass storage devices for storing data files; such devices include magnetic disks, such as internal hard disks and removable disks; magneto-optical disks; and optical disks.

Methods described herein may represent processing that occurs within a system for protecting OT devices (e.g., system 300 of FIG. 3). The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, such as EPROM, EEPROM, flash memory device, or magnetic disks. The processor and the memory can be supplemented by, or incorporated in, special purpose logic circuitry.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing illustrative embodiments, it is understood that the present disclosure has been made only by way of example, and that numerous changes in the details of implementation of the disclosed subject matter may be made without departing from the spirit and scope of the disclosed subject matter.

1. A method performed by a server for protecting a network infrastructure comprising:
receiving, from an inline hardware appliance that proxies traffic associated with an asset, traffic associated with the asset;
analyzing the traffic based on a behavioral fingerprint associated with the asset to determine if the traffic is normal or abnormal, wherein the behavioral fingerprint is stored on the server; and
in response to determining that the traffic is normal, forwarding the traffic to the asset.

2. The method of claim 1 comprising:
determining if the traffic is incoming or outgoing; and
in response to determining that the traffic is incoming and abnormal, blocking the traffic from being received by the asset.

3. The method of claim 2, wherein determining that the traffic is abnormal comprises determining that the traffic will cause downtime on the asset.

4. The method of claim 1 comprising;
determining if the traffic is incoming or outgoing; and
in response to determining that the traffic is outgoing and abnormal, determining that the asset is compromised.

5. The method of claim 4 comprising, in response to determining that the asset is compromised, gaining remote control of the asset.

6. The method of claim 5 comprising performing remote command executions on the asset with existing libraries of the asset.

7. The method of claim 4 comprising, in response to determining that the asset is compromised, isolating the asset from other assets on the network infrastructure.

8. The method of claim 1 further comprising updating the behavioral fingerprint.

9. A method performed by a server for protecting a network infrastructure comprising:
receiving identification information for a plurality of assets on a network; and
for each asset:
connecting the asset through an inline hardware appliance that proxies traffic, wherein the inline hardware appliance is configured to route traffic associated with the asset to the server;
generating a behavioral fingerprint for the asset;
storing the behavioral fingerprint on the server; and
using the behavioral fingerprint to control traffic associated with the asset.

10. The method of claim 9, wherein generating the behavioral fingerprint for the asset comprises:
monitoring traffic associated with the asset continuously and for a predetermined length of time; and
generating the behavioral fingerprint based on received traffic data.

11. The method of claim 10, wherein traffic data comprises at least one of:
frequencies of traffic;
identification information of other assets that communicate with the asset;
traffic packet sizes;
traffic packet timestamps;
time and duration information from when the asset is turned off;
time and duration information from when the asset is turned on; or
sensor data from a sensor of the asset.

12. The method of claim 11, wherein generating the behavioral fingerprint based on the received traffic data comprises using machine learning to generate an algorithm configured to predict whether a traffic packet associated with the asset is normal or abnormal.

13. The method of claim 9, wherein using the behavioral fingerprint to control traffic associated with the asset comprises:
receiving, from the inline hardware appliance, a traffic packet associated with the asset;
analyzing the traffic packet based on the behavioral fingerprint to determine if the traffic packet is normal or abnormal; and
in response to determining that the traffic packet is normal, forwarding the traffic packet to the asset.

14. The method of claim 13 comprising:
determining if the traffic packet is incoming or outgoing; and
in response to determining that the traffic packet is incoming and abnormal, blocking the traffic packet from being received by the asset.

15. The method of claim 13 comprising;
determining if the traffic packet is incoming or outgoing; and
in response to determining that the traffic packet is outgoing and abnormal, determining that the asset is compromised.

16. The method of claim 15 comprising, in response to determining that the asset is compromised, controlling the asset using only resources of the asset.

17. The method of claim 13 further comprising updating the behavioral fingerprint.

18. The method of claim 9, wherein connecting the asset to the inline hardware appliance comprises configuring the inline hardware appliance to route all traffic associated with a media access control (MAC) address of the asset to the server.

19. A system for protecting a network infrastructure comprising:
a network;
a plurality of assets connected to the network; and
a server connected to the network, the server comprising a plurality of proxies, wherein the server is configured to, for each asset on the network:
connect a proxy to the asset;
generate a behavioral fingerprint for the asset;
store the behavioral fingerprint on the server; and
use the behavioral fingerprint to control traffic associated with the asset;
wherein each proxy of the plurality of proxies is configured to route traffic associated with a connected asset to the server.

20. The system of claim 19, wherein generating the behavioral fingerprint comprises using machine learning to generate an algorithm configured to predict whether a traffic packet associated with the asset is normal or abnormal.
